(19) United States
(12) Patent Application Publication
(10) Pub. No.: US 2010/0295743 A1
(43) Pub. Date: Nov. 25, 2010

(54) Antenna Structure With Reconfigurable Pattern And Manufacturing Method Thereof

(76) Inventors: Ta-Chun Pu, Kaohsiung (TW); Chun-Yih Wu, Taichung (TW); Hung-Hsuan Lin, Taipei (TW)

Correspondence Address: LIN & ASSOCIATES INTELLECTUAL PROPERTY, INC., P.O. BOX 2339, SARATOGA, CA, 95070-0339, US

(21) Appl. No.: 12/613,534

(22) Filed: Nov. 6, 2009

(30) Foreign Application Priority Data
May 20, 2009 (TW) 098116721

(51) Int. Cl. H01Q 9/00; H01P 11/00

(52) U.S. Cl. 343/749; 29/600

(57) ABSTRACT

The invention provides an antenna structure with reconfigurable pattern, which comprises a grounded plane, at least an active antenna electrically connected to an RF signal source, at least a current dragger electrically connected to the grounded plane, and a controller. The at least an active antenna and the at least a current dragger are distributed on or near the grounded plane. The controller disables or enables the at least a current dragger at an operating frequency band to switch the RF current applied to the grounded plane to flow into or against the at least a current dragger, thereby a plurality of radiation patterns may be configured.

### TECHNICAL FIELD

The present invention generally relates to an antenna structure with reconfigurable pattern and the manufacturing method thereof.

### BACKGROUND

The smart antenna is an important part of antenna design for the wireless communication system, mainly including multiple input multiple output (MIMO) antenna technology and adaptive antenna system (AAS). MIMO antenna technology uses multiple wireless transmission paths to increase the signal coverage area or the amount of transmission data.

AAS technology uses multiple antennas to form an antenna array, dynamically adjusts the input power for each antenna unit for beam steering towards the target devices for data transmission, and achieves high efficient transmission by increasing signal to noise ratio (SNR) and reducing same frequency interference. In the mean time, if a dynamic object, such as human or other obstacles, blocks the signal transmission path to interfere, the system will readjust the beam steering in real time to form new transmission path and continue the transmission.

The antenna array has a high directivity (or the narrow main beam beamwidth) configuration precision. As shown in FIG. 1, the way to adjust the directivity of antenna array 100 requires a plurality of phase adjusters 110, power adjusters 120, a power divider 130, and a digital signal processor (DSP) 140. By configuring the phase and amplitude of the input signal to each antenna to achieve the effect of beam direction switch, the overall volume and the cost of smart antenna are also increased.

The configuration of antenna radiation pattern may be realized in many ways, such as, array antenna (multiple antennas), changing the electromagnetic coupling, changing the RF current distribution, and so on. The array antenna approach is to control the excited phase and amplitude of each antenna to composite a specific radiation pattern. The changing electromagnetic coupling approach, such as Yagi antenna, configures passive antenna to wave-guided or reflective structure to change the beam direction. The exemplary Yagi antenna structures are disclosed in U.S. Pat. No. 7,268,738, No. 7,193,574, No. 7,180,465, No. 6,753,826, and No. 6,211,830.

Take Yagi antenna structure 220 of FIG. 2A as an example. Yagi antenna 200 includes a reflective back plane 202, two passive antennas 203 (left and right), and an active antenna 201. Passive antennas may change the resonance length by connecting capacitive or inductive load to determine whether the effect is a wave-guided or reflective structure. FIG. 2B-FIG. 2D use the yz-cross-section of Yagi antenna structure 200 to describe the theory of the wave-guided or reflective structure.

For example, in FIG. 2B, the left passive antenna may be connected to an inductive load to increase the resonance length to become reflective structure 203a, where reflector 203a is longer indicating left passive antenna connected to inductive load to increase the resonance length. In FIG. 2C, the right passive antenna may be connected to capacitive load to shorten the resonance length to become director 203b, where director 203b is shorter indicating right passive antenna connected to capacitive load to shorten the resonance length. In FIG. 2D, reflector 203a and director 203b make the main beam direction of active antenna 201 leaning to the right.

Reflective back plane 202 is to make the beam radiate in the x-direction. The Yagi antenna structure theory may increase the antenna directivity, which is not related to the pattern configuration. This type of antenna has a configuration structure with maximum beam steering angle 180°, and the active antenna must have the same polarization as the passive antenna. In other words, the wave-guided or reflective structure must be parallel with the active antenna.

FIGS. 3A-3C show three similar antenna structures with corresponding radiation patterns. As shown in FIGS. 3A-3C, the antenna on three antenna structures 311-313 with different RF currents will generate different radiation patterns 321-323. In FIG. 3A, balanced antenna 311 has a symmetrical structure so that the RF current displays symmetrical distribution; therefore, radiation pattern 321 is also symmetrical. In FIG. 3B, unbalanced antenna structure 312 having the system grounded plane as part of the antenna radiation metal. Because the structure is asymmetrical, the asymmetrical RF current distribution makes the beam direction leaning towards the system grounded plane.

The unbalanced antenna structure and system grounded plane have different relative position, the RF current distribution will also be different, as shown in FIGS. 3B-3C, therefore, will have different radiation patterns 322, 323 and optimal signal reception direction will also be different.

The changing RF current approach to realize the antenna radiation pattern is disclosed in U.S. Pat. No. 6,456,248, No. 7,084,816, No. 6,771,223, No. 6,441,787, No. 7,202,823.

Take the antenna device disclosed by U.S. Pat. No. 7,084,816 of FIG. 4 as an exemplar. Antenna device 400 includes a grounded conductor 410, auxiliary ground conductors 420a, 420b, an antenna element 430, and changing elements 440a, 440b. Antenna element 430 is placed on top of grounded conductor 410 through an insulator. Auxiliary ground conductors 420a, 420b are separate from first ground conductor 410. Changing elements 440a, 440b change the direction of antenna element 420 through the configuration between grounded conductor 410 and auxiliary grounded conductor 420a, and through the configuration between grounded conductor 410 and auxiliary grounded conductor 420b, respectively. The auxiliary grounded conductors 420a, 420b are only for the extension of the ground plane, which do not affect the resonance frequency of antenna element 430 and need not resonate with the operating frequency of antenna element 430. Besides, antenna device 400 is a patch type antenna.

FIG. 5 shows a portable wireless communication device disclosed by U.S. Pat. No. 6,456,248. In wireless communication device 500, under the first and the second radio frequencies, the input impedance at open ends of conductor planar plate 511 is approaching infinity. The function is to prevent RF current from flowing into conductor planar plate 511 and shield case 502 so that the wireless communication system, under any RF, may reduce the average of specific absorption rate (SAR) of electromagnetic wave energy per unit mass.

### SUMMARY

The disclosed embodiments may provide an antenna structure with reconfigurable pattern and manufacturing method thereof.

In an exemplary embodiment, the disclosed relates to an antenna structure with reconfigurable pattern, comprising a grounded plane, at least an active antenna electrically connected to an RF signal source, at least a current dragger electrically connected to the grounded plane, and a controller. The at least an active antenna and the at least a current dragger are distributed on or near the grounded plane. The controller disables or enables the at least a current dragger at an operating frequency band to switch the RF current applied to the grounded plane to flow into or against the at least a current dragger, thereby a plurality of radiation patterns are configured.

In another exemplary disclosed embodiment, the disclosed relates to a manufacturing method for an antenna structure with reconfigurable radiation patterns. The method comprising: distributing or placing at least an active antenna near a grounded plane and electrically connecting to an RF signal; electrically connecting at least a current dragger to the grounded plane and regulating the guide-in/cut-off mode of current dragger within an antenna operating frequency band and corresponding current path; ensuring each current dragger under guide-in/cut-off mode effectively guiding in or cutting off the RF current on the grounded plane to the current dragger; distributing or placing the current draggers near the grounded plane; and within the antenna operating frequency band, by enabling or disabling the current dragger, reconfiguring the RF current guide-in/cut-off on the grounded plane to the current dragger.

The foregoing and other features, aspects and advantages of the present invention will become better understood from a careful reading of a detailed description provided herein below with appropriate reference to the accompanying drawings.

### BRIEF DESCRIPTION OF THE DRAWINGS

FIG. 1 shows an exemplary schematic view of an array antenna structure.

FIG. 2A shows an exemplary schematic view of a Yagi antenna structure.

FIGS. 2B-2D show an exemplary schematic view of the theory of wave-guide or reflective structure of FIG. 2A.

FIGS. 3A-3C show three similar types of antenna structures and corresponding radiation patterns.

FIG. 4 shows an exemplary schematic view of an antenna device.

FIG. 5 shows an exemplary schematic view of an antenna device and a portable wireless communication device.

FIG. 6 shows an exemplary schematic view of antenna structure with reconfigurable radiation patterns, consistent with certain disclosed embodiments.

FIGS. 7A-7B show exemplary schematic views of antenna radiation pattern change through configuring modes of antenna structure, consistent with certain disclosed embodiments.

FIGS. 8A-8C show exemplary schematic views of three embodiments of pseudo antenna type current dragger, consistent with certain disclosed embodiments.

FIGS. 9A-9C show schematic views of three exemplary resonator type current draggers, consistent with certain disclosed embodiments.

FIG. 10 shows an exemplary schematic view of the multi-port resonator of FIGS. 9A-9C, consistent with certain disclosed embodiments.

FIG. 11A shows a schematic view of an exemplary monopole type current dragger, consistent with certain disclosed embodiments.

FIG. 11B shows an exemplary schematic view of an antenna structure with a monopole type current dragger of FIG. 11A, consistent with certain disclosed embodiments.

FIGS. 12A-12B show the antenna radiation patterns corresponding to the grounded plane current distribution of antenna structure of FIG. 11 in cut-off/guide-in modes, respectively, consistent with certain disclosed embodiments.

FIG. 13 shows an exemplary schematic view of a working example of an antenna with reconfigurable radiation pattern, consistent with certain disclosed embodiments.

FIG. 14A shows an enlarged view of a pseudo antenna type current dragger of FIG. 8A, consistent with certain disclosed embodiments.

FIG. 14B shows an exemplary schematic view of an antenna structure, where a region in the antenna structure having an active antenna and two pseudo type antenna current draggers of FIG. 8A, consistent with certain disclosed embodiments.

FIG. 14C shows an enlarged view of the region of FIG. 14B, consistent with certain disclosed embodiments.

FIGS. 15A-15B show an exemplary antenna radiation pattern corresponding to a current dragger in cut-off mode and a current dragger in guide-in mode as in FIG. 14C, consistent with certain disclosed embodiments.

FIGS. 16A-16B show an exemplary antenna radiation pattern corresponding to two current draggers of FIG. 14C in guide-in mode, consistent with certain disclosed embodiments.

FIGS. 17A-17B show an exemplary antenna radiation pattern corresponding to two current draggers of FIG. 14C in cut-off mode, consistent with certain disclosed embodiments.

FIG. 18 shows an exemplary schematic view of the comparison of antenna radiation patterns of FIGS. 15-17, consistent with certain disclosed embodiments.

FIG. 19 shows an exemplary schematic view of a pair of antenna structures with reconfigurable radiation pattern having six types of radiation patterns, consistent with certain disclosed embodiments.

FIG. 20A shows an exemplary enlarged view of resonator type current dragger of FIG. 9B, consistent with certain disclosed embodiments.

FIG. 20B shows an exemplary schematic view of an antenna structure having a resonator type current dragger of FIG. 20A, consistent with certain disclosed embodiments.

FIG. 21A shows an exemplary schematic view of the antenna structure of FIG. 20B cutting off RF current from the resonator type current dragger when the resonator type current dragger is configured to the cut-off mode, consistent with certain disclosed embodiments.

FIG. 21B shows an exemplary schematic view of the antenna radiation pattern corresponding to the scenario of FIG. 21A, consistent with certain disclosed embodiments.

FIG. 22A an exemplary schematic view of the antenna structure of FIG. 20B guiding in RF current to the resonator type current dragger when the resonator type current dragger is configured to the guide-in mode, consistent with certain disclosed embodiments.

FIG. 22B shows an exemplary schematic view of the antenna radiation pattern corresponding to the scenario of FIG. 22A, consistent with certain disclosed embodiments.

FIG. 23 shows an exemplary flowchart of the method for manufacturing the antenna structure with reconfigurable radiation patterns, consistent with certain disclosed embodiments.

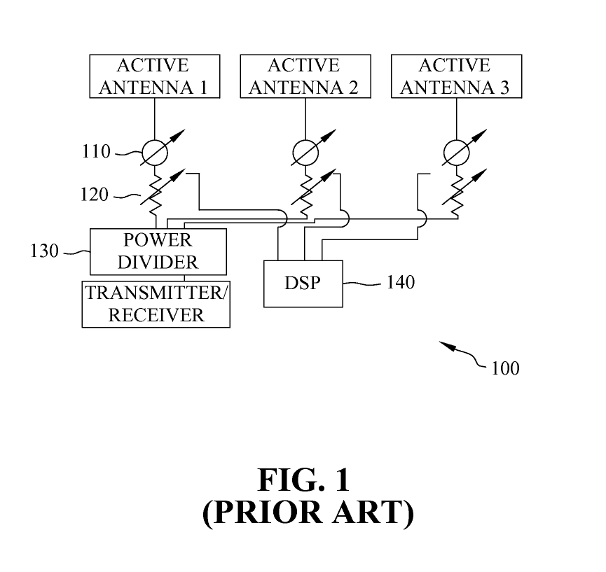

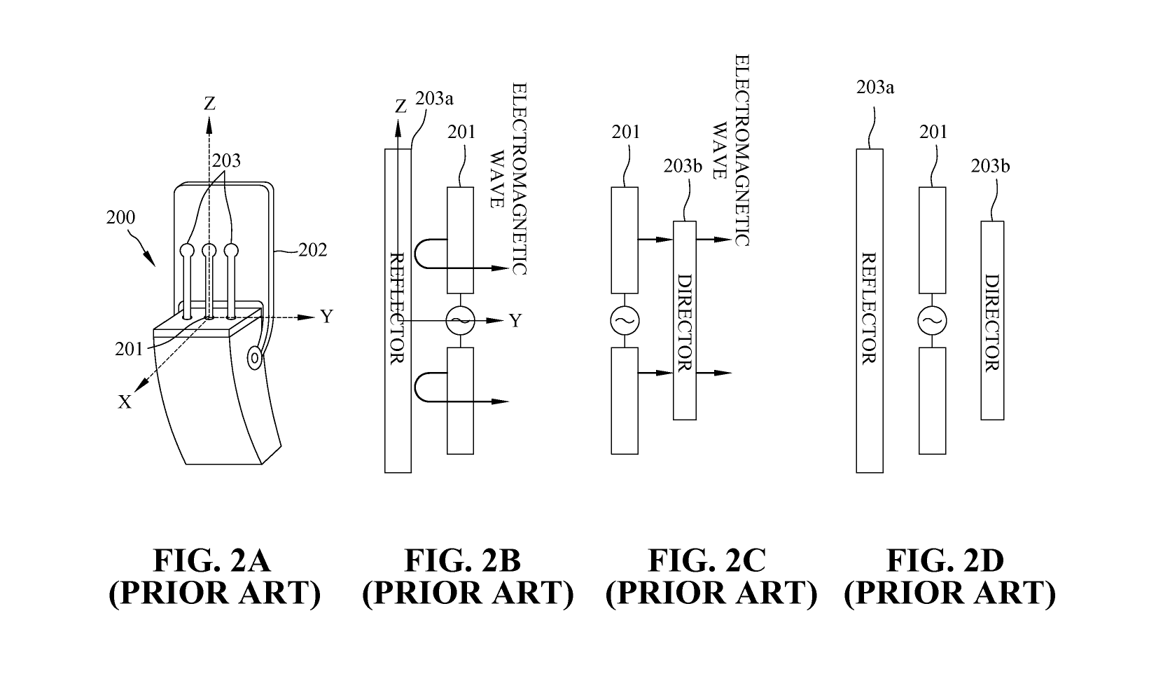

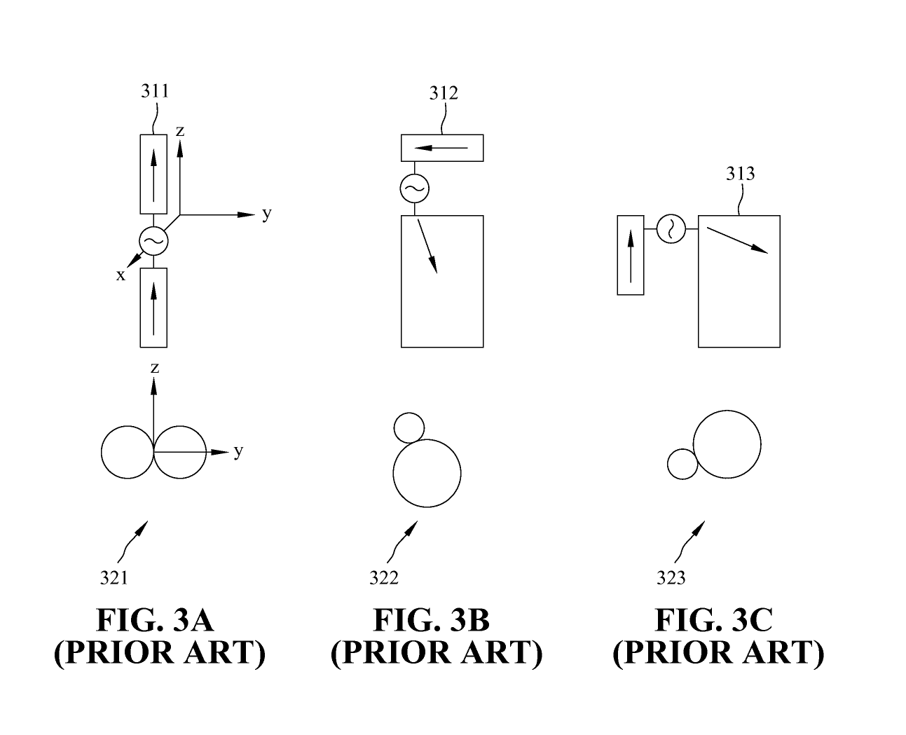

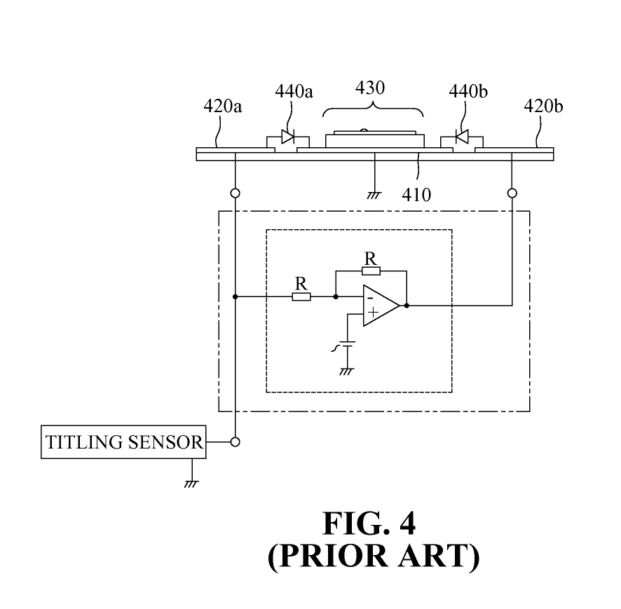

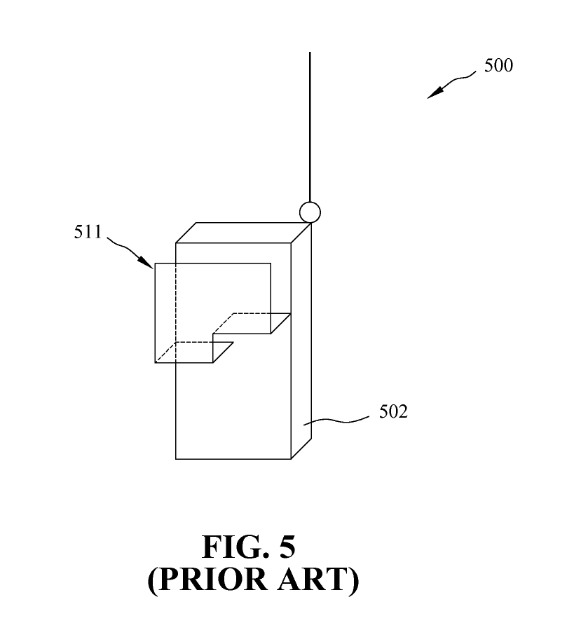

### DETAILED DESCRIPTION OF THE PREFERRED EMBODIMENTS

The disclosed exemplary embodiment of the present invention may provide an antenna structure with reconfigurable patterns. The antenna structure views an antenna grounded plane as a part of the antenna radiating body. At least a current dragger, through a controller to control a switching element embedded in the current dragger, guides in or cuts off the RF current on the grounded plane to the current dragger to control the RF current distribution on the antenna grounded plane, thereby forming a plurality of antenna radiation patterns.

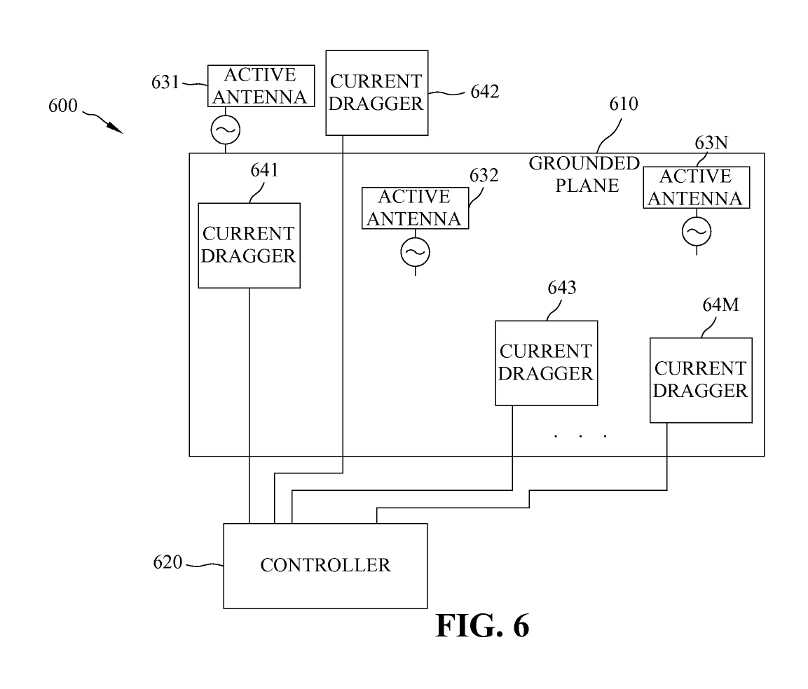

The exemplary embodiment of FIG. 6 discloses an antenna structure with reconfigurable pattern, consistent with certain disclosed embodiments. Referring to FIG. 6, antenna structure 600 comprises a grounded plane 610, N active antennas 631-63N, M current draggers 641-64M, and a controller 620, where N and M are both positive integers. Active antennas 631-63N are electrically connected to an RF signal. Current draggers 641-64M are electrically connected to grounded plane 610. Active antennas 631-63N and current draggers 641-64M are distributed on or near grounded plane 610. When within antenna operating frequency band, controller 620 enables or disables current draggers 641-64M to configure the RF current of grounded plane 610 to guide in or cut off to current dragger 641-64M to form a plurality of radiation patterns.

For example, in FIG. 6, controller 620 may be connected to current draggers 641-64M, and each of current dragger 641-64M may have at least a switch or an adjustable load. When a switch or an adjustable load of current dragger 641-64M is configured to the guide-in mode, the RF current on the grounded plane is guided into the current dragger corresponding to the switch or the adjustable load. On the other hand, if the switch or the adjustable load is configured to the cut-off mode, the input impedance of the current dragger towards RF current may be viewed as open, and the RF current on the grounded plane is cut off from the corresponding current dragger.

The guide-in mode and the cut-off mode may be regulated by controller 620 to control current dragger to whether to resonate in the operating frequency band. For example, when the switch or the adjustable load of a current dragger is configured to the guide-in mode, the current dragger resonates within the operating frequency band and shows low input impedance towards the RF current. Therefore, the RF current may be guided into the current dragger. When the current dragger is configured to the cut-off mode, within the operating frequency band, the current dragger shows high input impedance to the RF current, i.e., the RF current is cut off from the current dragger.

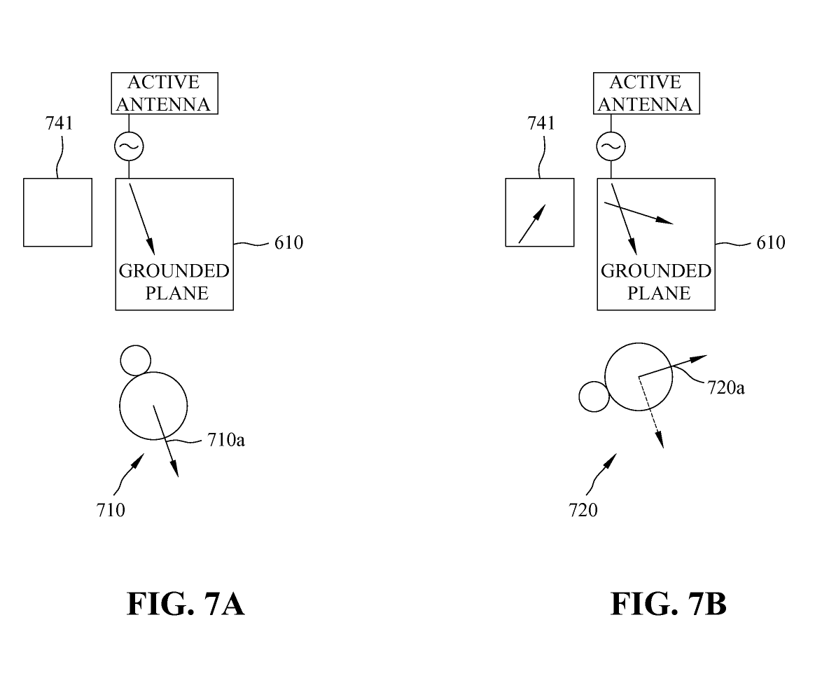

FIGS. 7A-7B show exemplary schematic views of antenna radiation pattern change through configuring modes of antenna structure, consistent with certain disclosed embodiments. As shown in FIG. 7A, when the antenna structure is in the antenna operating frequency band and current dragger 741 is disabled, i.e., cut-off mode, current dragger's input impedance to RF current may be viewed as open, where the arrow of grounded plane is the direction of the RF current, and mark 710a is the main beam direction of antenna radiation pattern 710. As shown in FIG. 7B, when the antenna structure is in the antenna operating frequency band and current dragger 741 is enabled, i.e., guide-in mode, RF current is guided into current dragger 741 so that the main beam direction of antenna radiation pattern 720 is roughly reconfigured from toward down to toward right, marked as 720a.

After a current dragger is added to an active antenna, the radiation pattern is the linear superposition of the radiation patterns formed by the RF current distributions of the two active antennas (i.e., one is the active antenna, and the other one is the active antenna replacing the current dragger), where relative phase and amplitude of the current dragger to the active antenna RF current is a factor of the linear coefficient of the radiation pattern formed by the RF current distribution of the other active antenna.

Therefore, the disclosed embodiments may affect the RF current on the grounded plane through reconfiguring each current dragger to guide in or cut off the RF current. Different configuration combinations allow the antenna structure to form different RF current distributions. The change of RF current distribution on the grounded plane will affect the far field pattern (directivity) and the near field electromagnetic energy distribution of the antenna, such as specific absorption rate (SAR) of electromagnetic energy per mass unit. Therefore, the antenna structure will have the reconfigurable patterns.

In comparison with the technique of prior arts to change antenna radiation pattern by electromagnetic coupling, the disclosed exemplary embodiments does not impose any restriction on the polarization and distance between the active antenna and the passive antenna. Hence, the disclosed exemplary embodiments may be applicable to the low profile antenna structure.

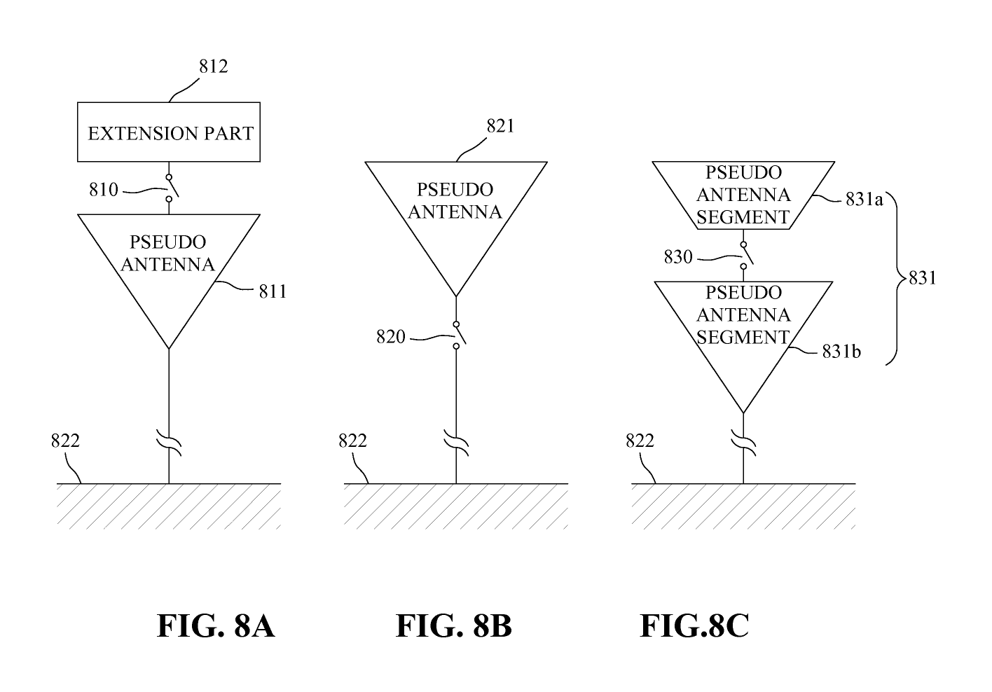

The current dragger may be realized by, for example, pseudo antenna type, resonator type, or monopole type. FIGS. 8A-8C show three exemplars of pseudo antenna type current dragger, consistent with certain disclosed embodiments, where the switch element of the current dragger can be, for example, a switch or an adjustable load. The following examples use a switch for description.

In FIG. 8A, switch 810 of pseudo antenna type current dragger is located between pseudo antenna 811 and an extension 812 of pseudo antenna 811. In FIG. 8B, switch 820 of pseudo antenna type current dragger is located between pseudo antenna 821 and grounded plane 822. In FIG. 8C, switch 830 of pseudo antenna type current dragger is located inside pseudo antenna 831; in other words, switch 830 is located between two segments of pseudo antennas 831a, 831b. The aforementioned pseudo antenna may be a conductor, such as metal plate. RF current may be coupled or directly flow into the pseudo antenna.

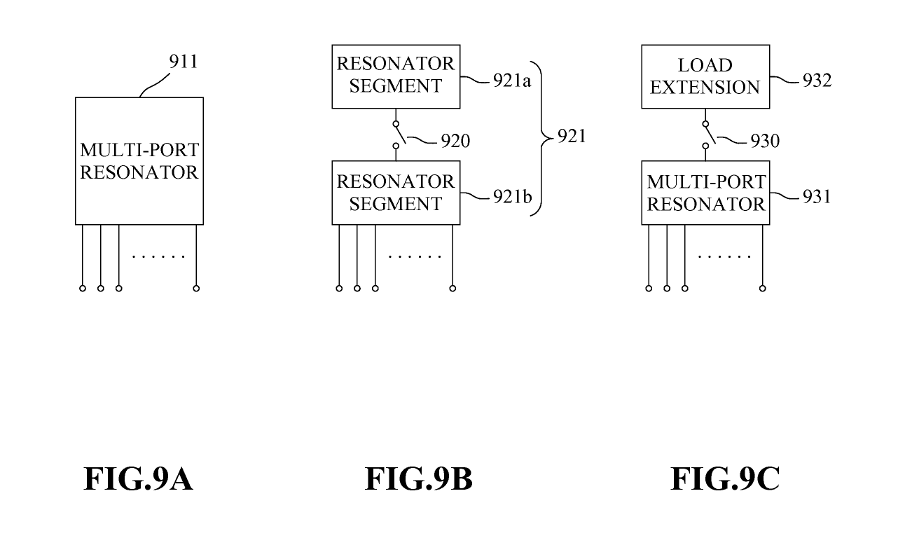

FIG. 9A and FIG. 9C are two exemplary schematic views of resonance type current draggers, consistent with certain disclosed embodiments. In FIG. 9A, resonance type current dragger is realized with a multi-port resonator 911. In FIG. 9B and FIG. 9C, the switch element of the resonance type current dragger may be a switch or an adjustable load. The following uses switch for explanation. In FIG. 9B, switch 920 of resonance type current dragger is designed to be located inside a multi-port resonator 921. In other words, switch 920 is placed between two resonator segments 921a, 92b. In FIG. 9C, switch 930 of resonance type current dragger is designed to be located between multi-port resonator 931 and an extended load 932 of multi-port resonator 931. Multi-port resonator 931 is connected to extended load 932 through switch 930, and may switch the resonance frequency.

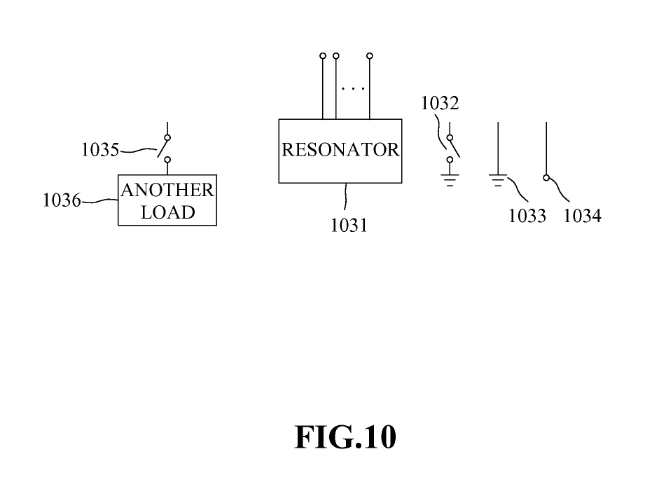

As shown in FIG. 10, the connection structure of the output terminal of the aforementioned multi-port resonator may be open 1034, shorted (grounded) 1033, or connected to a switch element, such as switch 1032, and then grounded, or connected to another resonator 1031, or connected to a switch element, such as switch 1035, and then connected to another load 1036.

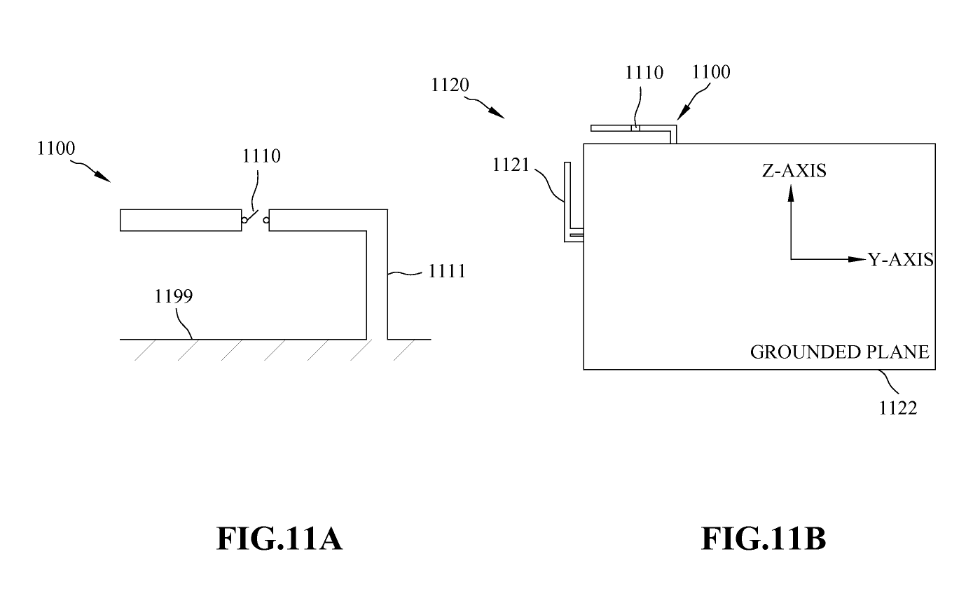

FIG. 11A shows a schematic view of a monopole type current dragger according to the present invention. As shown in FIG. 11A, the switch element of monopole type current dragger 1100, such as switch 1110, is located between two segments of L-arm 1111. L-arm 1111 has one termination grounded 1199. FIG. 11B shows an exemplary schematic view of an antenna with monopole type current dragger 1100, consistent with certain disclosed embodiments, where antenna structure 1120 includes active antenna 1121 and monopole type current dragger 1100, both placed on the outside of grounded plane 1122.

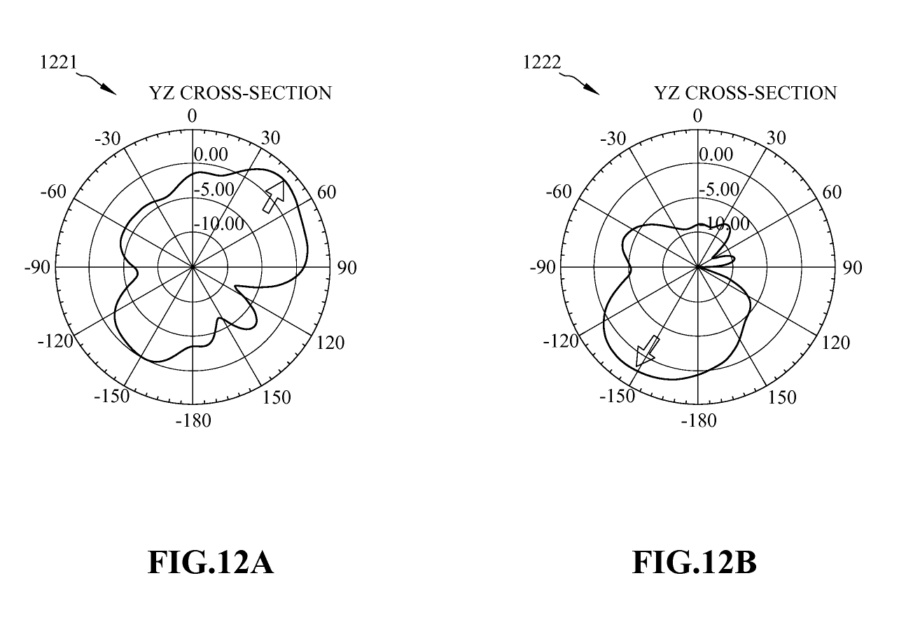

FIG. 12A and FIG. 12B show the antenna radiation patterns corresponding to the grounded plane current distributions of aforementioned antenna structure 1120 in cut-off and guide-in modes respectively, consistent with certain disclosed embodiments. In FIG. 12A, antenna structure 1120 is in the cut-off mode and the main beam direction of antenna radiation pattern faces the 45° direction. In FIG. 12B, antenna structure 1120 is in the guide-in mode. Because the current dragger's guiding in the RF current has increased another current direction on the grounded plane, the main beam of the antenna radiation pattern faces the −155° direction. In other words, the exemplary antenna structure may be configured to have main beam facing 45° direction or −155° direction.

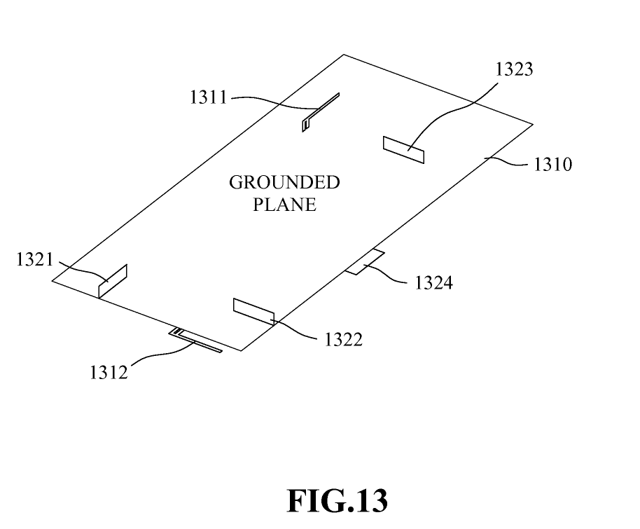

FIG. 13 shows an exemplary schematic view of a working example of the antenna with configurable radiation patterns, consistent with certain disclosed embodiments. As shown in FIG. 13, active antenna 1311 and current draggers 1321-1323 can be placed on a grounded plane 1310, and active antenna 1312 and current dragger 1324 can be placed outside of grounded plane 1310. In other words, current draggers are neither limited to be co-planar with the active antenna, nor limited to be co-planar with the grounded plane.

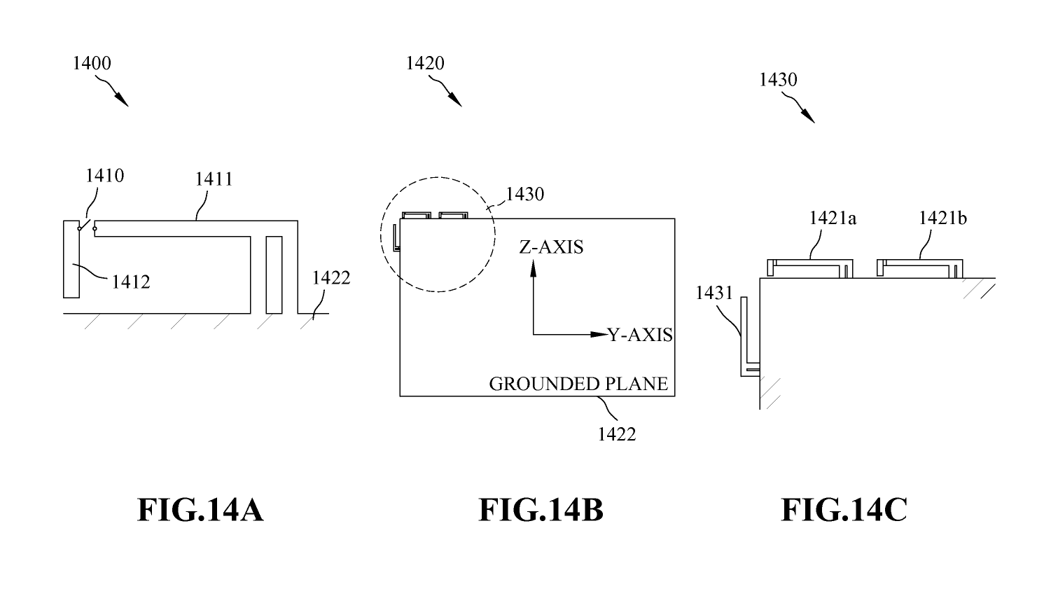

The following uses the pseudo type current dragger of FIG. 8A as an example to describe the antenna radiation patterns corresponding to the two pseudo antenna type current draggers in an antenna structure in different configurations. FIG. 14A-FIG. 14C show respectively the pseudo antenna type current dragger, the antenna structure and the two pseudo antenna type current draggers of the antenna structure.

FIG. 14A shows an exemplary view of an actual structure of the pseudo type current dragger of FIG. 8A, consistent with certain disclosed embodiments. As shown in FIG. 14A, pseudo antenna type current dragger 1400 comprises an extended part 1412, pseudo antenna 1411, and switch 1410 located between the above two. Mark 1422 is the grounded plane of the antenna structure.

FIG. 14B shows an exemplary schematic view of an antenna structure with a plurality of current draggers, consistent with certain disclosed embodiments. As shown in FIG. 14B, region 1430 of antenna structure 1420 has an active ante and two pseudo antenna type current draggers 1400 located outside of grounded plane 1422. In the embodiment, the size of grounded plane 1422 is 260 mm*180 mm. FIG. 14C shows an enlarged view of region 1430, where mark 1431 is active antenna and two pseudo antenna type current draggers are marked as 1421a, 1421b. The following describes antenna radiation patterns corresponding to two pseudo antenna type current draggers 1421a, 1421b in different configuration modes.

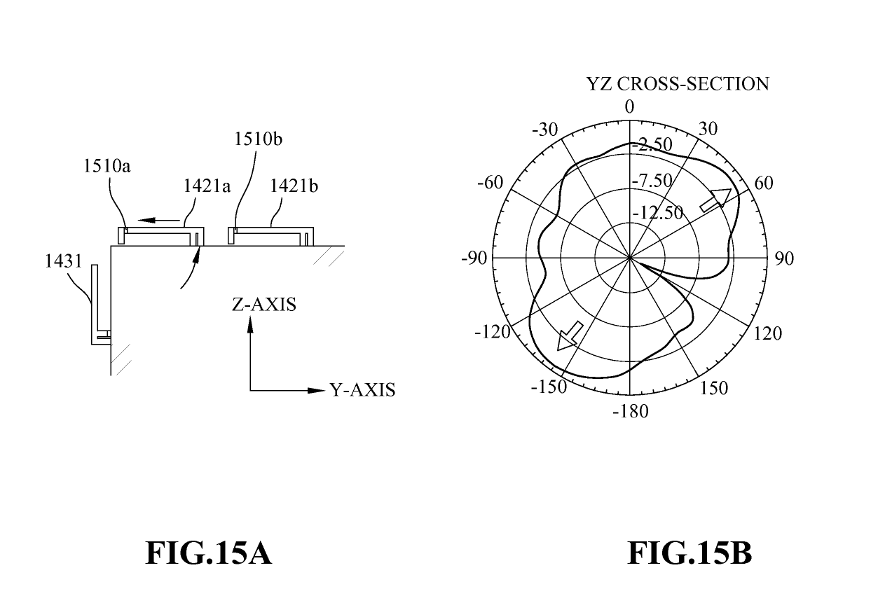

In FIG. 15A, pseudo antenna type current dragger 1421a is in guide-in mode. In other words, switch 1510a is in OFF state; therefore, the guided-in RF current flows in the direction of arrow. Pseudo antenna type current dragger 1421b is in cut-off mode. In other words, switch 1510b is in ON state; therefore, the RF current is cut off and virtually no RF current is present. With pseudo antenna type current dragger 1421a in guide-in mode and pseudo antenna type current dragger 1421b in cut-off mode, FIG. 15B shows the antenna radiation pattern corresponding to the current distribution on grounded plane 1422 of antenna structure 1420. The main beams of antenna radiation pattern face the −135° and 55° directions, respectively, as the arrows indicate.

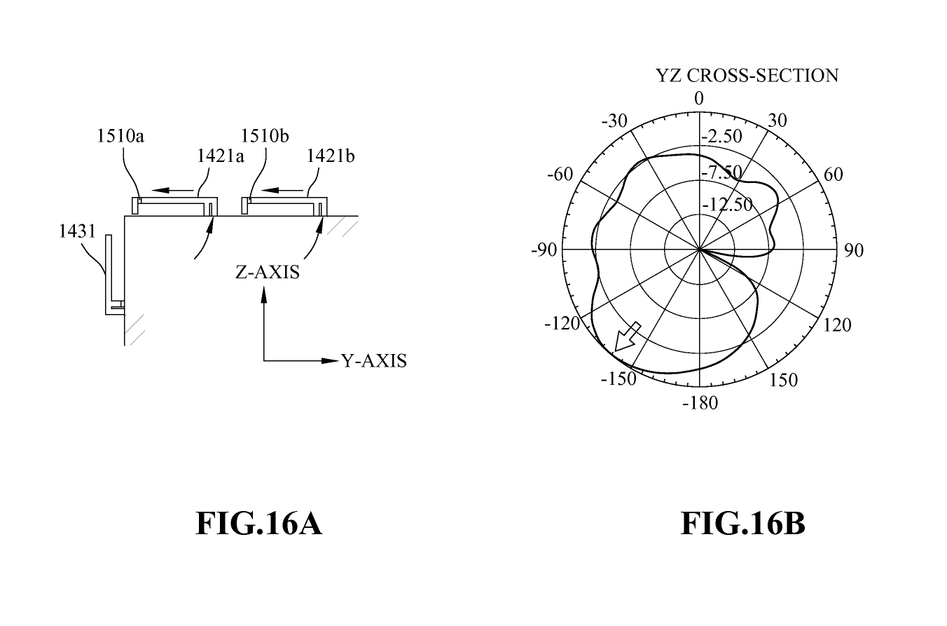

In FIG. 16A, pseudo antenna type current draggers 1421a, 1421b are both in guide-in mode. In other words, switches 1510a, 1510b are both in OFF state; therefore, the guided-in RF current flows in the direction of arrow. With pseudo antenna type current draggers 1421a, 1421b both in guide-in mode, FIG. 16B shows the antenna radiation pattern corresponding to the current distribution on grounded plane 1422 of antenna structure 1420. The main beams of antenna radiation pattern face the −135° direction, as the arrow indicates.

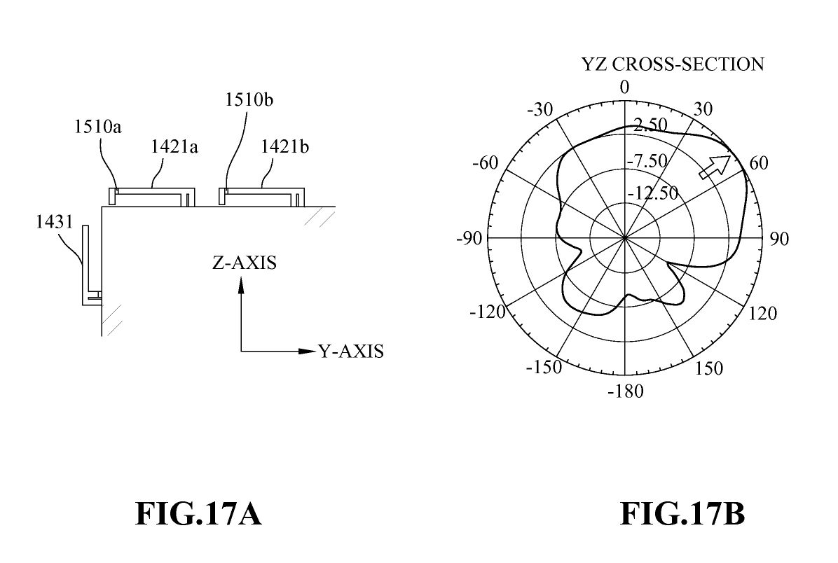

In FIG. 17A, pseudo antenna type current draggers 1421a, 1421b are both in cut-off mode. In other words, switches 1510a, 1510b both are in ON state; therefore, the RF current is cut off and virtually no RF current is present. With pseudo antenna type current draggers 1421a, 1421b both in cut-off mode, FIG. 17B shows the antenna radiation pattern corresponding to the current distribution on grounded plane 1422 of antenna structure 1420. The main beams of antenna radiation pattern face the 55° direction, as the arrow indicates.

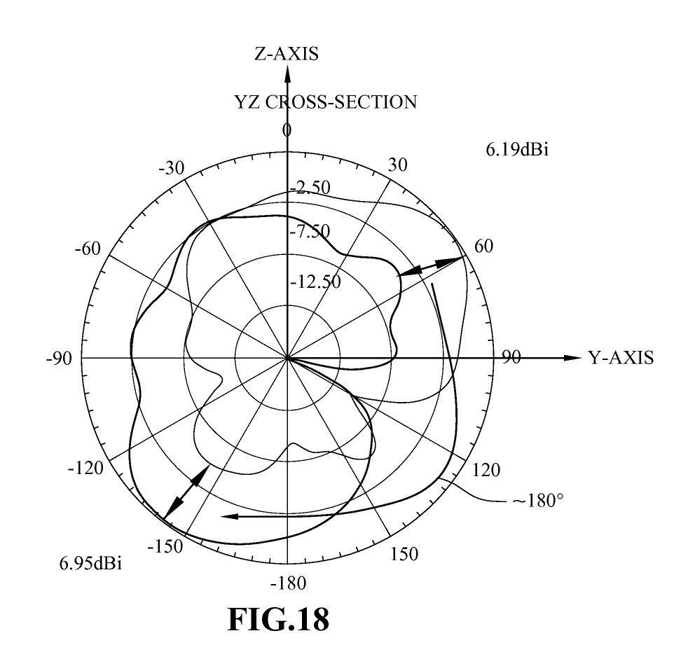

In the exemplary embodiments of FIG. 15-FIG. 17, the main beam of antenna ration patterns can be configured to face 55°, −135° and 55°, −135° dual-beam. FIG. 18 shows the comparison of antenna radiation patterns of FIG. 16, FIG. 17. It is observed that the reconfiguration covers the range of nearly 180°, where the antenna gain of beam direction (about) −135° of FIG. 16B is about 6.95 dBi more than that of FIG. 17B, while, vice versa, the antenna gain of beam direction (about 55°) of FIG. 17B is about 6.95 dBi more than that of FIG. 16B.

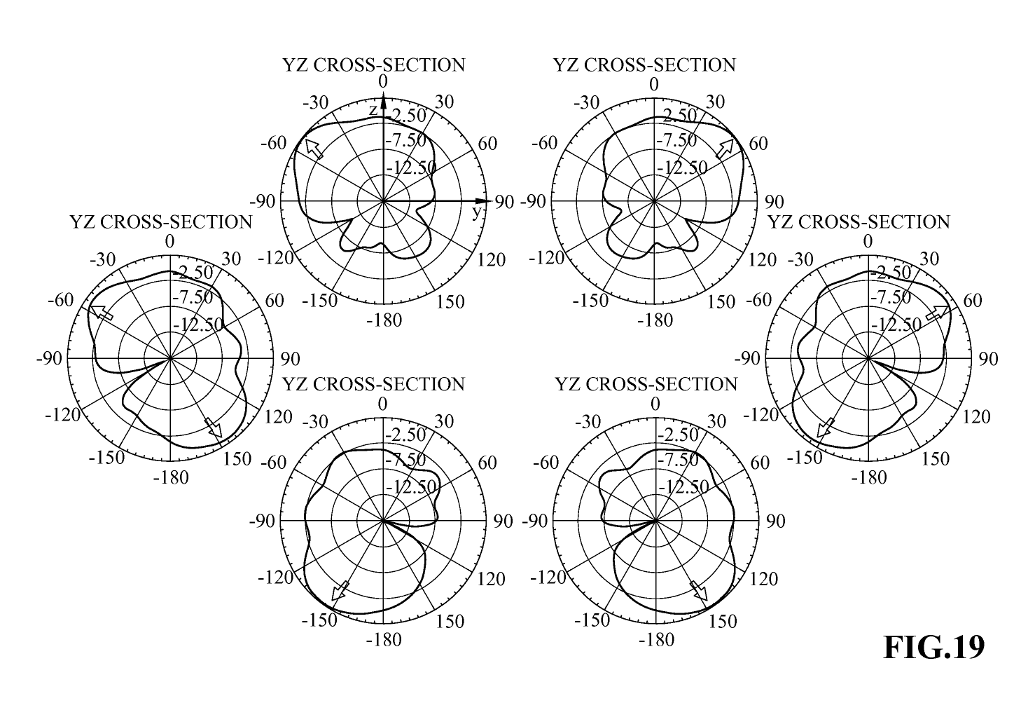

FIG. 19 shows that a pair of antenna structure with reconfigurable radiation patterns may display six different radiation patterns, consistent with certain disclosed embodiments. In the exemplary embodiment, the size of grounded plane is 220 mm*180 mm.

The disclosed exemplary embodiments also simulate the location change of current dragger to observe the change of antenna radiation pattern and current distribution. The simulation result shows that the location change of current dragger will lead to different RF current distribution on grounded plane; thus, the radiation pattern will be different. The simulation may be used as reference when determining the location of current dragger.

The following uses resonator type current dragger of FIG. 9B as an example to describe the antenna radiation patterns corresponding to the resonator type current dragger in an antenna structure in different configuration modes.

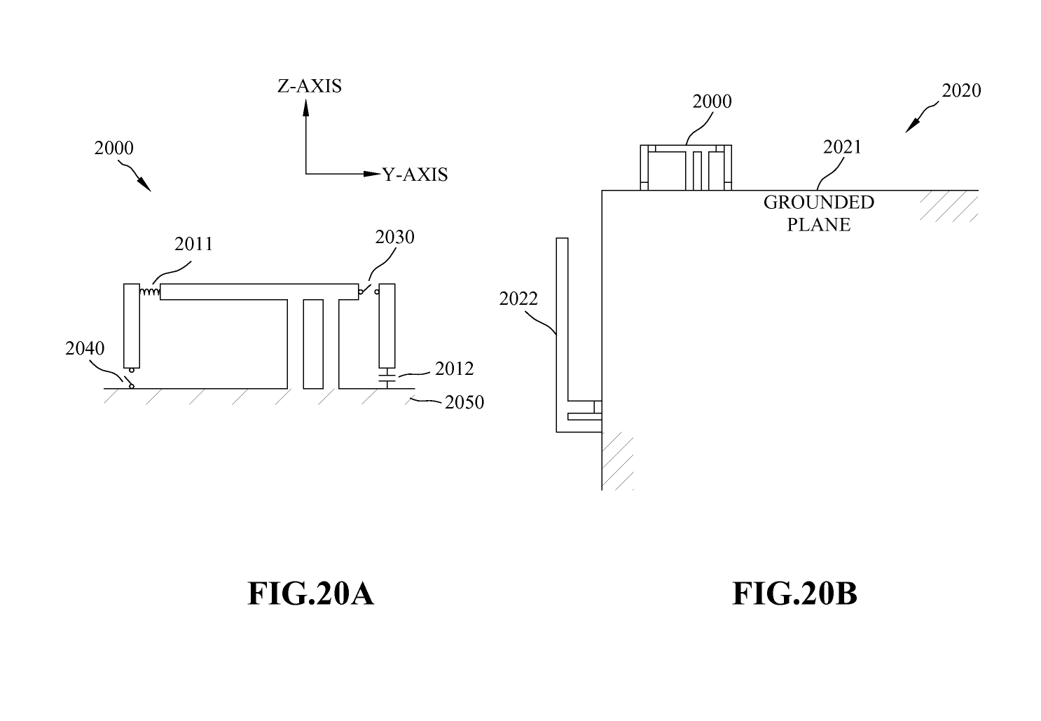

FIG. 20A shows a cross-sectional view of the resonator type current dragger of FIG. 9B, consistent with certain disclosed embodiments. As shown in FIG. 20A, resonator type current dragger 2000 is a multi-port resonator with inductor 2011 and capacitor 2012, and switch 2030 is designed to be located inside the multiport-resonator. The output termination of the multi-port resonator is connected to a switch element 2040 and then grounded 2050.

FIG. 20B shows an exemplary schematic view of an antenna structure with a resonator type current dragger 2000, consistent with certain disclosed embodiments, where antenna structure 2020 has a grounded plane 2021, and an active antenna 2022 and a resonator type current dragger 2000 located outside of grounded plane 2021. In the exemplary embodiment, the size of grounded plane 2021 is 260 mm*180 mm.

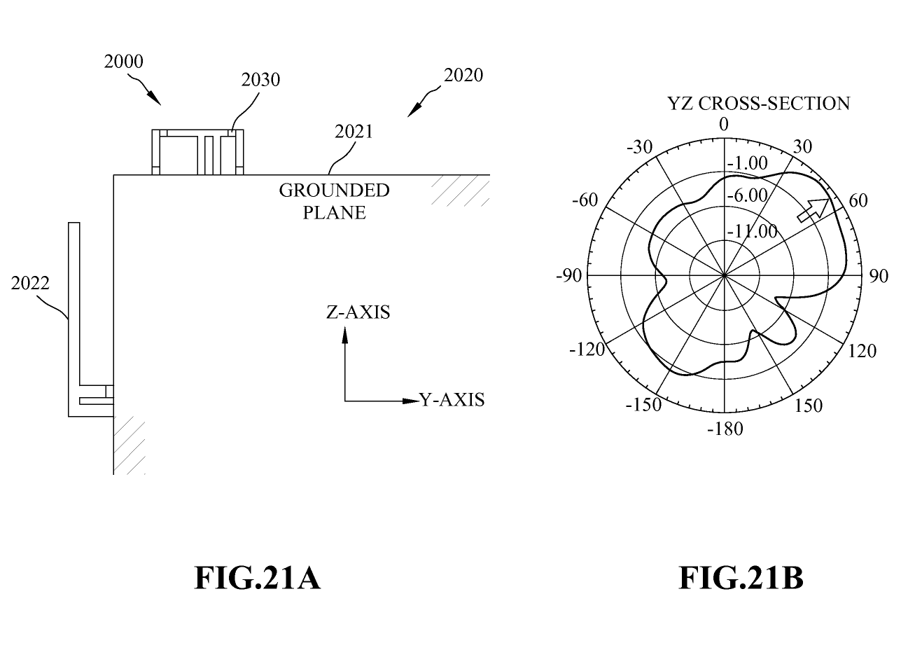

When resonator type current dragger 2000 is in the cut-off mode, as shown in FIG. 21A, switch 2030 of resonator type current dragger 2000 is in ON state; therefore, the RF is cut off and virtually no RF current is present. In the cut-off mode, FIG. 21B shows the antenna radiation pattern corresponding to the current distribution on grounded plane 2021 of antenna structure 2020. The main beam of antenna radiation pattern faces the 45° direction, as the arrow indicates.

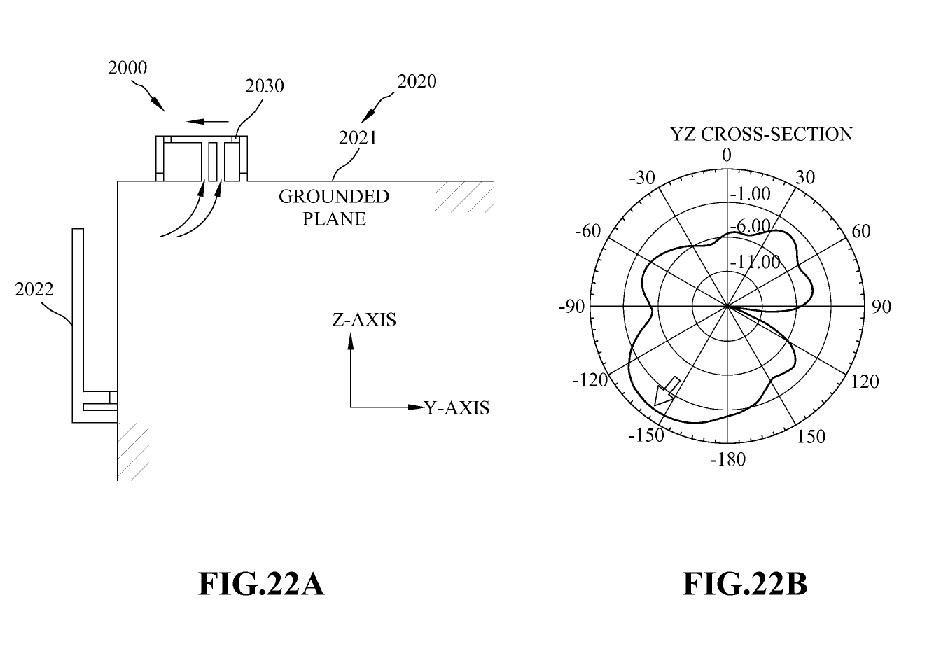

When resonator type current dragger 2000 is in the guide-in mode, as shown in FIG. 22A, switch 2030 of resonator type current dragger 2000 is in OFF state; therefore, the RF current is guided in following the direction indicated by the arrow. In the guide-in mode, FIG. 22B shows the antenna radiation pattern corresponding to the current distribution on grounded plane 2021 of antenna structure 2020. The main beam of antenna radiation pattern faces the −155° direction, as the arrow indicates.

The above simulation result shows that the antenna radiation patterns obtained by using a resonator type current dragger are the same as the radiation patterns obtained by using pseudo antenna type current dragger. This is because the resonator can only drag in the RF current, but not radiate. Therefore, it proves that the antenna structure of the disclosed exemplary embodiments may reconfigure, by enabling or disabling the current dragger, the guide-in or cut-off of the RF current of the grounded plane to or from the current dragger to change the RF current distribution of the antenna grounded plane, instead of using electromagnetic coupling effect to change the antenna RF current distribution on the grounded plane. In comparison with the cell phone without the current dragger, the simulation result of average SAR value shows that the present invention can reduce the impact of electromagnetic wave on human.

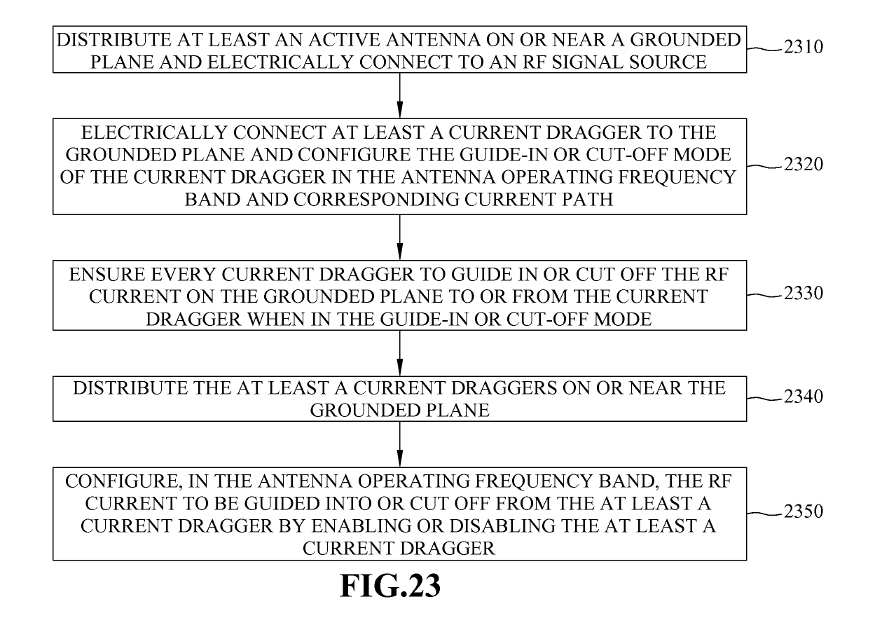

The following describes the design flow of the antenna structure of the disclosed exemplary embodiments. FIG. 23 shows an exemplary flowchart of the method for manufacturing the antenna structure with reconfigurable radiation patterns, consistent with certain disclosed embodiments. Referring to FIG. 23, in step 2310, at least an active antenna is distributed on or near a grounded plane and electrically connected to an RF signal source. In step 2320, at least a current dragger is electrically connected to the grounded plane and configured the guide-in or cut-off mode of the current dragger in the antenna operating frequency band and corresponding current path. Step 2330 is to ensure every current dragger to guide in or cut off the RF current on the grounded plane to or from the current dragger when in the guide-in or cut-off mode. Then, the at least a current draggers are distributed on or near the grounded plane, as shown in step 2340. Step 2350 is to configure, in the antenna operating frequency band, the RF current to be guided into or cut off from the at least a current dragger by enabling or disabling the at least a current dragger.

As aforementioned, the configuration of guide-in/cut-off mode determines whether the current dragger resonates in the antenna operating frequency band. The current dragger may be realized with pseudo antenna type, resonator type or monopole type current dragger. The locations and the numbers of current draggers and the active antennas may also be changed to match the actual application demands of multiple radiation characteristics.

In actual application, for example, an active antenna may be designed following the specification and simulations may be performed to understand how the current of the active antenna distributes in the frequency operating band. According to the actual requirement, the current dragger may be pseudo antenna type, resonator type, monopole type or hybrid type. The configuration mechanism and current path of the current draggers in the resonance/non-resonance modes in the operating frequency band. The configuration mechanism may be switch element or adjustable load.

In step 2330, the actual application, for example, may simulate the frequency response of each current dragger in resonant/non-resonant modes to check whether the RF current on the grounded plane may be effectively guided into or cut off from the current dragger to ensure that each current dragger can effectively guide in or cut off the RF current on the grounded plane to or from the current dragger in the guide-in or cut-off modes.

In step 2350, for example, a controller may be used to enable or disable the current draggers to configure the guiding in or cutting off the RF current on the grounded plane to or from the current dragger. In the guide-in mode, the RF current may be guided into the current dragger by coupling or direct flowing.

In summary, the disclosed exemplary embodiments may provide an antenna structure with reconfigurable pattern and manufacture method thereof. The antenna structure uses a controller to enable or disable switches or adjustable load to configure a current dragger in operating frequency band so that the RF current on the grounded plane may be guided into or cut off from the current dragger. In this manner, the antenna structure may show different current distributions. The changed RF current distribution on grounded plane may also affect the antenna far-field pattern (directivity) and near-field electromagnetic energy distribution. The current dragger may be realized with various structures, such as pseudo antenna type, resonator type or monopole type. The direction change of main beam may be achieved up to near 180°. The disclosed exemplary embodiments are also applicable to the antenna structure with low profile.

Although the disclosed has been described with reference to the exemplary embodiments, it will be understood that the invention is not limited to the details described thereof. Various substitutions and modifications have been suggested in the foregoing description, and others will occur to those of ordinary skill in the art. Therefore, all such substitutions and modifications are intended to be embraced within the scope of the invention as defined in the appended claims.

What is claimed is:

1. An antenna structure with reconfigurable radiation pattern, comprising:
a grounded plane;
at least an active antenna, distributed on or near said grounded plane and electrically connected to an RF signal source;
at least a current dragger, distributed on or near said grounded plane and electrically connected to said grounded plane; and
a controller that configures to guide in or cut off RF current on said grounded plane to or from said at least a current dragger by enabling or disabling said at least a current dragger in an antenna operating frequency band, to form a plurality of radiation patterns.

2. The antenna structure as claimed in claim 1, wherein each of said at least a current dragger comprises at least a switch element.

3. The antenna structure as claimed in claim 1, wherein each of said at least a current dragger comprises at least an adjustable load.

4. The antenna structure as claimed in claim 1, wherein each of said at least a current dragger is selected from a group of current draggers with pseudo antenna type, resonator type and monopole type.

5. The antenna structure as claimed in claim 4, wherein said resonator type current dragger is a multi-port resonator.

6. The antenna structure as claimed in claim 5, wherein a connection structure of output terminal of said multi-port resonator is selected from a group of connection structures with open, short, connecting to a switch element then grounded, connecting to another resonator, and connecting to a switch element and then connecting to another load.

7. The antenna structure as claimed in claim 4, wherein said switch element of said pseudo antenna type current dragger is located between a pseudo type antenna and an extension part of said pseudo type antenna.

8. The antenna structure as claimed in claim 4, wherein said switch element of said pseudo antenna type current dragger is located between a pseudo type antenna and said grounded plane.

9. The antenna structure as claimed in claim 4, wherein said switch element of said pseudo antenna type current dragger is located inside a pseudo type antenna.

10. The antenna structure as claimed in claim 1, wherein said controller is electrically connected to each of said at least a current dragger.

11. The antenna structure as claimed in claim 1, wherein said controller checks whether said current dragger resonates in said antenna operating frequency band to enable or disable said at least a current dragger while in said antenna operating frequency band.

12. The antenna structure as claimed in claim 1, wherein said at least a current dragger is not restricted to be co-planar with said active antenna.

13. The antenna structure as claimed in claim 1, wherein said at least a current dragger is not restricted to be co-planar with said grounded plane.

14. A method for manufacturing antenna structure with reconfigurable radiation patterns, said method comprising:
distributing at least an active antenna on or near a grounded plane, and electrically connecting said active antenna to an RF signal source;
electrically connecting at least a current dragger to said grounded plane, and configuring a guide-in or cut-off mode of said current dragger within an antenna operating frequency band and a corresponding current path;
ensuring each of said at least a current dragger effectively guiding in or cutting off RF current on said grounded plane to or from said current dragger while said current dragger in guide-in/cut-off mode;
distributing said current dragger on or near said grounded plane; and
within said antenna operating frequency band, enabling or disabling said at least a current dragger to reconfigure said RF current on said grounded plane guided into or cut off from said at least a current dragger.

15. The method as claimed in claim 14, said method configures said guide-in or cut-off mode depending on whether said at least a current dragger resonates in said antenna operating frequency band.

16. The method as claimed in claim 14, wherein each of said at least a current dragger is selected from a group of current draggers with pseudo antenna type, resonator type and monopole type.

17. The method as claimed in claim 14, said method further includes:
simulating frequency response of each of said at least a current dragger in guide-in/cut-off mode to ensure each of said at least a current dragger effectively guiding in or cutting off RF current on said grounded plane to or from said at least a current dragger while said current dragger in said guide-in/cut-off mode.

18. The method as claimed in claim 14, wherein, in guide-in mode, RF current on said grounded plane is guided into said at least a current dragger by coupling or direct flowing.

19. The method as claimed in claim 14, said method enables or disables said at least a current dragger by a controller to configure whether RF current on said grounded plane guided into or cut off from said at least a current dragger within said antenna operating frequency band.

20. The method as claimed in claim 14, said method further includes:
adjusting locations of said current dragger and said active antenna to meet actual application requirements of plural radiation characteristics.

21. The method as claimed in claim 14, said method further includes:
adjusting the number of said at least a current dragger and said active antenna to meet actual application requirements of plural radiation characteristics.

22. The method as claimed in claim 14, said method further includes:
simulating current distribution on said grounded plane when said at least an active antenna being within said antenna operating frequency band.

23. The method as claimed in claim 19, wherein each of said at least a current dragger has at least a switch element for configuring to guide in or cut off RF current on said grounded plane to or from said current dragger.

24. The method as claimed in claim 19, wherein each of said at least a current dragger has at least an adjustable load for configuring to guide in or cut off RF current on said grounded plane to or from said current dragger.
